(19) United States
(12) Patent Application Publication
(10) Pub. No.: US 2026/0304103 A1
(43) Pub. Date: Oct. 1, 2026

(54) END-TO-END DATA COLLECTION TRIGGERING MECHANISMS

(71) Applicant: InterDigital Patent Holdings, Inc., Wilmington, DE (US)

(72) Inventors: Ulises Olvera-Hernandez, Saint-Lazare (CA); Oumer Teyeb, Montreal (CA); Alec Brusilovsky, Downingtown, PA (US); Jung Je Son, Warrington, PA (US); Michel Roy, Candiac (CA); Guanzhou Wang, Brossard (CA); Taimoor Abbas, Sainte-Julie (CA)

(73) Assignee: InterDigital Patent Holdings, Inc., Wilmington, DE (US)

(21) Appl. No.: 19/092,861

(22) Filed: Mar. 27, 2025

(51) Int. Cl. H04W 8/24; H04L 41/16

(52) U.S. Cl. CPC H04W 8/24; H04L 41/16

(57) ABSTRACT

Methods and apparatuses for operation by a Radio Access Network (RAN) node are provided. A method performed by a RAN node may comprise sending a request for permission to initiate data collection associated with training of an artificial intelligence/machine-learning (AI/ML) model; receiving an indication that the permission is granted; sending AI/ML configuration information to configure a wireless transmit/receive unit (WTRU) to perform the data collection; receiving a message indicating data collection capabilities of the WTRU; determining, based on the data collection capabilities, an ML training procedure for training the AI/ML model; sending a data collection request that initiates the data collection; receiving a data collection response that comprises a data collection session identifier associated with the data collection; and sending a notification to the WTRU that comprises additional AI/ML configuration information to configure the WTRU to perform the data collection based on the response to the data collection request.

### BACKGROUND

In the 5G system, there is limited support for Artificial Intelligence and/or Machine Learning (AIML). However, next generation systems (e.g., 6G) may provide more support for AIML functionality to enhance cellular network performance as measured by various metrics.

### SUMMARY

Methods and apparatuses for operation by a Radio Access Network (RAN) node (e.g., a gNB) are provided. In one example, a method performed by a Radio Access Network (RAN) node may comprise sending a request for permission to initiate data collection associated with training of an artificial intelligence/machine-learning (AI/ML) model; receiving, after the request is sent (e.g., in response to the request), an indication that permission is granted to initiate the data collection; sending artificial intelligence/machine-learning (AI/ML) configuration information to configure a wireless transmit/receive unit (WTRU) to perform the data collection; receiving, after the AI/ML configuration information is sent (e.g., in response to the AI/ML configuration information), a message indicating one or more data collection capabilities of the WTRU; determining, based on the one or more data collection capabilities of the WTRU, an ML training procedure for training the AI/ML model; sending a data collection request, wherein the data collection request initiates the data collection; receiving, after the data collection request is sent (e.g., in response to the data collection request), a data collection response, wherein the data collection response comprises a data collection session identifier associated with the data collection; and sending a notification to the WTRU, wherein the notification comprises additional AI/ML configuration information to configure the WTRU to perform the data collection based on the response to the data collection request.

The method may further comprise, prior to sending the request for permission to initiate the data collection associated with training of the AI/ML model, sending a message indicating one or more data collection capabilities of the RAN node.

The method may further comprise generating a training correlation identifier (ID); and sending the training correlation ID to a data correlation server function (DCSF) to help the DCSF identify a training process associated with the training of the AI/ML model.

The AI/ML model may be a WTRU-sided model and the training process may be performed at the WTRU.

The AI/ML model may be a network-sided model and the training process may be performed at the RAN node.

The AI/ML model may be a two-sided model and the training process may be a joint training process that comprises at least one action to be performed by the RAN node and at least one action to be performed by the WTRU.

The method may further comprise receiving a destination address of a data collection entity associated with the data collection.

The method may further comprise receiving data that was collected by the WTRU while the WTRU performed the data collection.

The method may further comprise receiving, from the WTRU, a protocol data unit (PDU) session identifier (ID) that was derived from the data collection session identifier and an indication of a PDU session type; using the PDU session ID and the PDU session type to insert additional information that is correlated with the data that was collected by the WTRU into a second message, wherein the second message comprises the data that was collected by the WTRU; and sending the second message to the destination address of the data collection entity.

The AI/ML configuration information may indicate a plurality of AI/ML operations for the WTRU to perform. The message may indicate that the WTRU is not capable of performing at least one of the AI/ML operations.

The method may further comprise, prior to sending the request for permission to initiate data collection associated with training of the AI/ML model, sending a request for the data collection capabilities of the WTRU; and receiving an indication of the data collection capabilities of the WTRU (e.g., after sending the request for the data collection capabilities of the WTRU and/or in response to the request for the data collection capabilities of the WTRU).

The permission to initiate the data collection may be associated with a policy provided by a policy control function (PCF) (e.g., a policy that is based on negotiation between the RAN node and the PCF with regard to the data collection). The AI/ML configuration information and/or the additional AI/ML configuration information may be based on the policy.

The AI/ML configuration information and/or the additional AI/ML configuration information may comprise an indication of a type of the AI/ML model (e.g., WTRU-sided, network-sided, and/or two-sided). The type of the AI/ML model may be based on a type of action for which the AI/ML model is to be used (e.g., channel state information compression or another type of action).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a diagram that depicts an example of a procedure specifically addressing Mobility Optimization.

FIG. 3 illustrates a flow chart that describes an example of a high-level procedure that triggers Data Collection from the RAN node.

FIG. 4 illustrates a diagram of an example procedure for initiating data collection.

FIG. 5 illustrates a diagram of an example procedure for mobility consideration for data collection.

### DETAILED DESCRIPTION

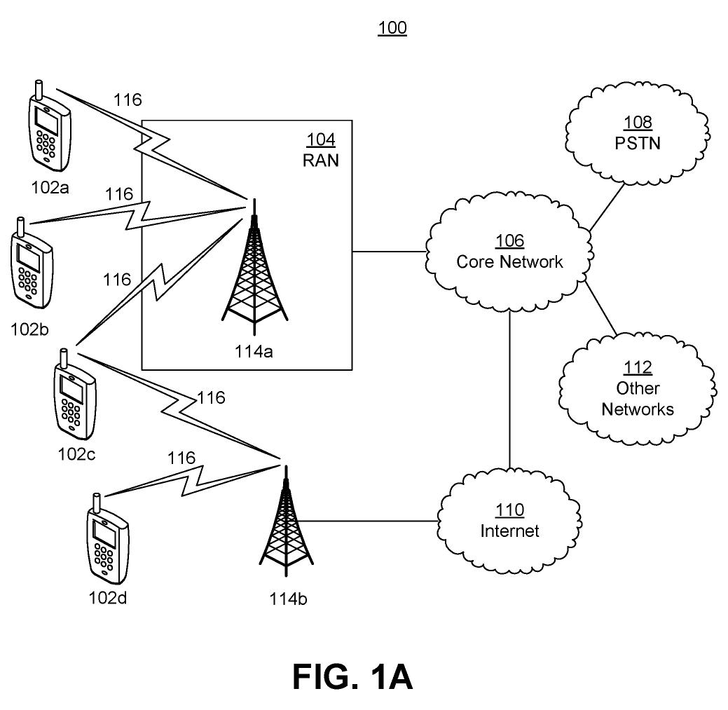

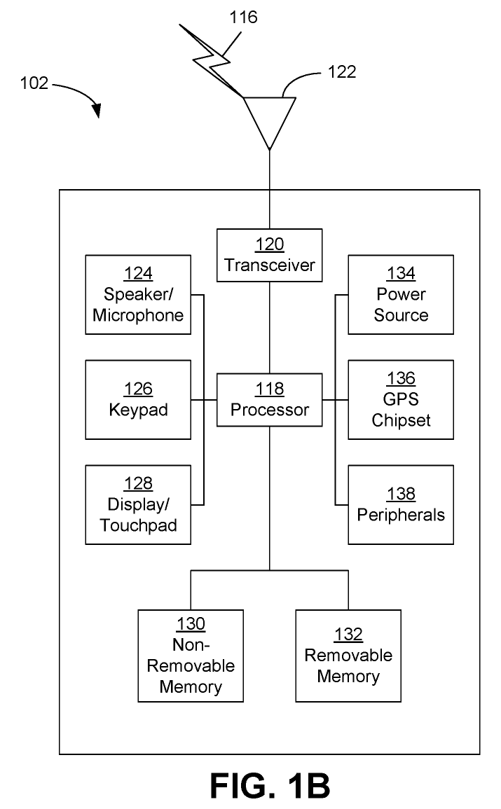

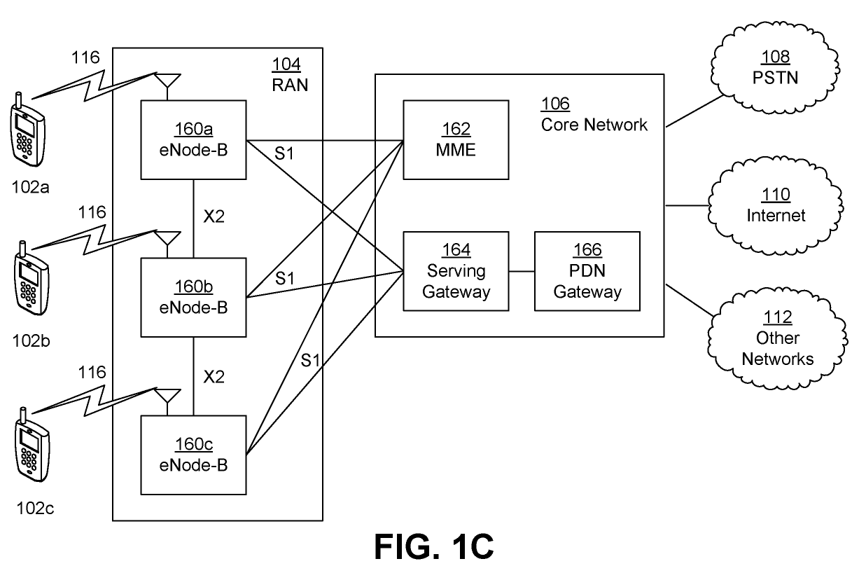

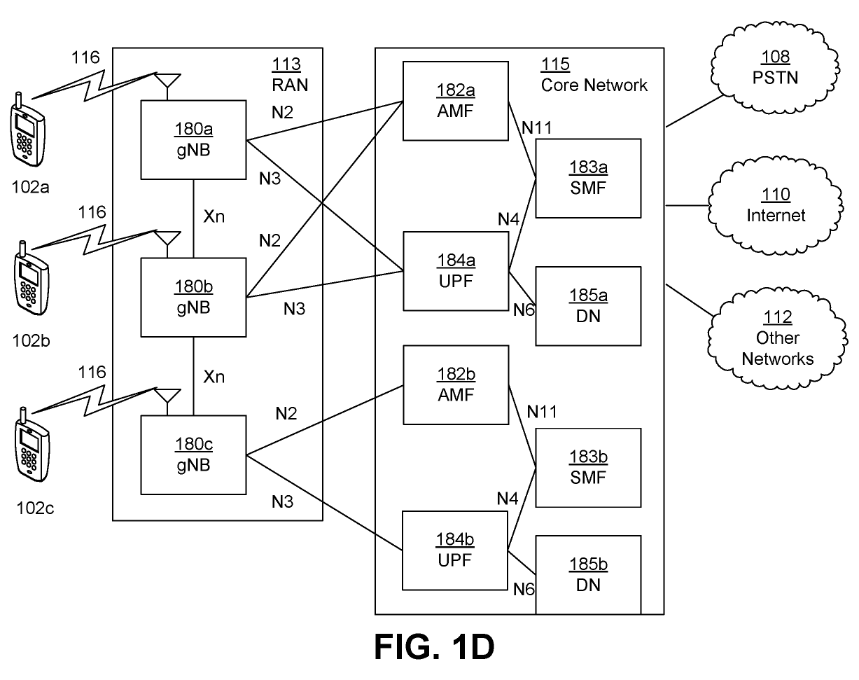

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160cmay each include one or more transceivers for communicating with the WTRUs 102a, 102b, 102c over the air interface 116. In one embodiment, the eNode-Bs 160a, 160b, 160cmay implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102cwith access to packet-switched networks, such as the Internet 110, to facilitate communications between the WTRUs 102a, 102b, 102cand IP-enabled devices.

The CN 106 may facilitate communications with other networks. For example, the CN 106 may provide the WTRUs 102a, 102b, 102cwith access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102cwith access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180cmay each include one or more transceivers for communicating with the WTRUs 102a, 102b, 102c over the air interface 116. In one embodiment, the gNBs 180a, 180b, 180cmay implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180cmay implement carrier aggregation technology. For example, the gNB 180amay transmit multiple component carriers to the WTRU 102a (not shown). A subset of these component carriers may be on unlicensed spectrum while the remaining component carriers may be on licensed spectrum. In an embodiment, the gNBs 180a, 180b, 180cmay implement Coordinated Multi-Point (CoMP) technology. For example, WTRU 102amay receive coordinated transmissions from gNB 180aand gNB 180b(and/or gNB 180c).

The WTRUs 102a, 102b, 102c may communicate with gNBs 180a, 180b, 180cusing transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102cmay communicate with gNBs 180a, 180b, 180cusing subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180cas a mobility anchor point. In the standalone configuration, WTRUs 102a, 102b, 102c may communicate with gNBs 180a, 180b, 180cusing signals in an unlicensed band. In a non-standalone configuration WTRUs 102a, 102b, 102cmay communicate with/connect to gNBs 180a, 180b, 180cwhile also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182bmay be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182bin order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182bin the CN 115 via an N11 interface. The SMF 183a, 183b may also be connected to a UPF 184a, 184b in the CN 115 via an N4 interface. The SMF 183a, 183bmay select and control the UPF 184a, 184band configure the routing of traffic through the UPF 184a, 184b. The SMF 183a, 183bmay perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102cwith access to packet-switched networks, such as the Internet 110, to facilitate communications between the WTRUs 102a, 102b, 102c and IP-enabled devices. The UPF 184, 184bmay perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102cwith access to the other networks 112, which may include other wired and/or wireless networks that are owned and/or operated by other service providers. In one embodiment, the WTRUs 102a, 102b, 102cmay be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Data collection may refer to the process of collecting data for the purpose of artificial intelligence and/or machine learning (AI/ML) model training, performance monitoring, data analytics and/or inference. Often, the collection of the data is performed by a WTRU, but in some cases (e.g., for two-sided models), it may also be performed by a network entity (e.g., gNB or local management function (LMF), if a two-sided model is used for channel state information (CSI) and/or positioning use cases).

The data (e.g., by the WTRU) may contain data related to measurements performed by the WTRU (e.g., radio signal level measurements and/or positioning related measurements).

Data transfer may refer to the sending and/or transfer of the collected data from the WTRU to a Data Collection Entity (e.g., a gNB, a Network Function, such as the LMF or the network data analytics function (NWDAF), the operations, administration, and management (OAM) system, or an over-the-top (OTT) server). In some cases, the model training and/or model performance monitoring may be performed at the server collecting the data. In some cases, the data collection entity may be different from the entity doing the model training and/or the entity performance monitoring.

AI/ML model may refer to a data-driven algorithm that applies AI/ML techniques to generate a set of outputs based on a set of inputs.

AI/ML model inference refers to a process of using a trained AI/ML model to produce a set of outputs based on a set of inputs. This specification does not differentiate between model inference and prediction.

WTRU-side (AI/ML) model may refer to an AI/ML Model whose inference is performed at the WTRU.

Network-side (AI/ML) model may refer to an AI/ML Model whose inference is performed at the network (e.g., a gNB, a Network Function, such as the LMF or the NWDAF, the OAM system or an OTT server)

Two-sided (AI/ML) model may refer to paired AI/ML Model(s) over which joint inference is performed, where joint inference comprises AI/ML Inference whose inference is performed jointly across the WTRU and the network (e.g., the first part of inference is first performed by WTRU and then the remaining part is performed by gNB, or vice versa).

A WTRU collecting data may or may not support AI/ML related functionalities or may not have any AI/ML models (e.g., the collected data may be used for training of WTRU side model of other WTRUs, the collected data may be used for the training of a network-side model—e.g., the gNB-side model).

Offline model training may refer to an AI/ML training process where the model is trained based on a collected dataset, and where the trained model is later used and/or delivered for inference (e.g., to a WTRU and/or AI Agent). It should be noted that the training of a model may involve the collection of data from multiple WTRUs over a certain period of time, and that the collected data may be used for training of WTRU-side models, network-side models, or the models that are involved in a two-sided model operation.

An AI training loop is a repetitive process where the model is iteratively trained (e.g., based on collected data) to minimize a predefined loss function.

The term ground truth (GT) may refer to the actual value of a certain measurement or information that is being predicted or estimated (e.g., in the case of cell and/or beam measurements, it is the actual signal level of the beam or the cell that is being predicted).

A WTRU may perform the actions (e.g., steps) described herein.

First, the WTRU sends a radio resource control (RRC) message (e.g., a first RRC message) to the radio access network (RAN) and a non-access stratum (NAS) message to the Core Network. The message indicates both to the RAN node and to the Core Network (e.g., to the data collection server function (DCSF)) that the WTRU is capable of performing data collection for AI/ML model training.

The NAS message may be sent to a Data Collection Server Function (DCSF).

The message (e.g., the RRC message and/or the NAS message) may indicate the conditions under which the WTRU may perform Data Collection as described in further detail below.

The RRC message may indicate (e.g., as part of the WTRU radio capability) that the WTRU may perform Data Collection and may indicate what type of model training it supports.

Next, the WTRU receives an RRC message (e.g., a second RRC message) from the Network. The message indicates to the WTRU the details of the Data Collection process (e.g., as described further below).

The received RRC message may be received from a RAN node supporting Data Collection Functionality. The received RRC message may indicate what model training type the WTRU is allowed to use, the ML model ID of the allowed ML model(s), and/or a training correlation ID the WTRU may use to identify the training process that involved Data Collection.

Next, the WTRU sends an RRC message (e.g., a third RRC message) indicating accepted Data Collection configuration. This RRC message (e.g., the third RRC message) indicates whether the WTRU can only support WTRU-side model training.

Alternatively or in addition to the first action listed above, the WTRU may send an indication to the network (e.g., to the RAN in an RRC message, to the CN in a NAS message, to both the RAN and CN in an RRC message that contains a NAS message indicating the information to both the RAN and CN, to a OAM entity) or an indication to an entity and/or a server outside the network (e.g., an application layer message to an OTT server where the data is to be collected, etc.).

The message (e.g., which contains the indication) may indicate the type of the data collection that the WTRU is capable of performing and/or consenting to perform and/or the conditions under which the WTRU can perform Data Collection as described further below. For example, the WTRU may indicate that it supports one or more data collection type IDs (e.g., where the data collection type IDs and the information to be collected may be defined in 3GPP specification—e.g., type ID A for data collection for beam prediction, type ID B for data collection for CSI prediction, etc.). A data collection type ID may be even more granular—e.g., the data collection type ID may indicate a purpose of the data collection (e.g., type ID A_1 for data collection for training of beam prediction models, type ID A_1 for data collection for performance monitoring of beam prediction models, etc.).

In some cases, the information to be collected may not be specified but the WTRU may indicate the information that the WTRU can collect (e.g., it may collect cell level measurements, etc.).

The capability information could also contain other aspects of data collection support. Some examples of such aspects of data collection are listed below.

In an example, the capability information may indicate a frequency and/or sampling rate of data collection (e.g., how many samples can be taken within a given time—this may be the same for each components of a sample or some components may be collected more often than others).

In an example, the capability information may indicate a total amount of data, in samples and/or actual bytes, that the WTRU may collect before reaching buffer limitations.

In an example, the capability information may indicate the validity of the data collection support. For instance, the capability information may indicate support that is location related (e.g., cells, RAN and/or tracking areas, public land mobile networks (PLMNs), etc.), time based, (e.g., time durations in which the WTRU is willing and/or capable of collecting data), and/or other limitations (e.g., that the WTRU is willing to do data collection only if the activity level of UP and/or cyclic prefix (CP) traffic below a certain level, if the WTRU is operating under single connectivity with carrier aggregation (CA) and/or data collection (DC), etc.).

The WTRU receives a response message from the entity to which the WTRU has sent the data collection capability (e.g., the capability information). The response message may indicate a request to initiate the data collection. This response message may indicate one or more of the types of information listed below.

In an example, the response message may indicate the type of the data to be collected (e.g., one or more the indicated data collection types that the WTRU has indicated that it supports).

In an example, the response message may indicate a data collection ID (e.g., which the WTRU may use to tag the collected data—e.g., in case the WTRU may perform several data collection processes simultaneously and/or use the same bearer or protocol data unit (PDU) session to send them, etc.). The response message may indicate measurement configuration for the data collection.

The message for the data collection initiation (e.g., the response message) may come from an entity different from the entity to which the WTRU has sent the data collection capability. For example, the WTRU may have sent the data collection capability information to an OTT server, the OTT server may have communicated with the RAN and/or CN (e.g., proprietary interface), and the data collection configuration may come from the RAN and/or CN (e.g., gNB, user plane function (UPF), access and mobility management function (AMF), LMF, etc.). Part of the configuration may also come from the entity that received the data collection capability, and part of the configuration may come from the RAN and/or CN.

The message for the data collection initiation may come from the entity where the WTRU sent the data collection capability, but it may lack some configuration information that the WTRU has to have to perform the data collection. In these cases, the WTRU may further send a request to the network (e.g., RAN/CN/LMF, etc.) to get (some and/or all of) the configuration information (e.g., the configuration for performing the required measurements, etc.).

In some cases (e.g., data collection for performance monitoring, data collection for fine tuning of an already trained model, etc.), the WTRU may also be configured to perform inference and collect both measurements (e.g., ground truth values) as well as inferred values from one or more AI/ML models. For example, the WTRU may be configured to activate the inference for models x and y, and include in the collected data the actual measurements, the inferred measurements using model x and the inferred measurements using model y, etc.

In some examples, if the WTRU can apply the received data collection initiation and/or configuration, the WTRU may immediately start the data collection.

In some examples, if the WTRU cannot apply the received data collection initiation and/or configuration (e.g., the configuration was instructing the WTRU to perform some measurements that WTRU is not capable of, or more measurements that WTRU is not capable of, or any other mismatch between WTRU capability and data collection configuration or any other WTRU configuration), the WTRU may send a rejection message (e.g., to the data collection entity, to the RAN/CN, etc.) to indicate that it can’t perform the data collection according to the received configuration (e.g.., including a cause value to the rejection).

If the data collection initiation and/or configuration contains aspects related to several types of data collection, the WTRU may partially fulfill the data collection configuration and/or requirements. For example, the data collection configuration may be indicating for the WTRU to perform data collection of type A and type B (e.g., for different AI/ML functionalities or sub functionalities), and the WTRU may be able to do the data collection for type A but not for type B. In these cases, the WTRU may be configured to perform one or more the actions listed in the examples below.

The WTRU may start the data collection for the data collection types that the WTRU can perform and send a partial rejection indication regarding the other data collection types that it cannot perform.

The WTRU may reject the whole data collection configuration and/or initiation (and include an indication in the rejection message of which types the data collection the WTRU cannot perform).

The WTRU, after sending a confirmation that it can do the data collection (fully or partially, as discussed above) according to the received configuration, may wait until the WTRU gets a further message to start the data collection (e.g., in case of partial fulfillment, the WTRU may receive an indication to start collecting data for the portions of the configurations for which it can perform the data collection, etc.).

The data collection configuration could also indicate certain conditions that have to be fulfilled for the WTRU to perform the data collection. Examples of such conditions may be WTRU speed or speed ranges, the current serving cell belonging (or not belonging) within a certain list of cells and/or RAN and/or tracking areas and/or PLMN(s), the signal level of the serving cell being above or below a certain threshold (or within a range of threshold values), etc. If such a condition is configured, the WTRU may pause the data collection when one or more of these conditions are not fulfilled. In some examples, the WTRU may stop the data collection completely if the conditions are not fulfilled (e.g., further request required to re-initiate the data collection even if the conditions get fulfilled again). For example, the WTRU may be configured to monitor and send an indication (e.g., to the network, to the data collection server outside the network, etc.) and may receive a response indicating the WTRU can resume the data collection. Similarly, the WTRU may be configured to send an indication if one or more of the conditions are no longer fulfilled while the WTRU is doing the data collection but resume the data collection unless the WTRU receives a subsequent message indicating that the WTRU is to stop and/or pause the data collection.

In some examples, instead of starting, stopping, pausing, and/or resuming the data collection when the conditions are met, the WTRU may be configured to log the current conditions along with the collected data samples. For example, the WTRU may be configured to log the one or more conditions discussed above along with each data sample being logged and/or collected (e.g., WTRU speed, serving cell signal level, current cell and/or location, etc.).

The WTRU may be configured to log an entry that does not contain the measurements, but only the conditions each time the one or more conditions change (e.g., if speed changes from one range to another range, WTRU may include one sample in the collected data that indicate the time of change and the new value of the speed, etc.).

A RAN node may perform any combination of the actions (e.g., steps) listed below.

The RAN node may receive an RRC message (e.g., a first RRC message) from the WTRU. The message indicates that the WTRU is capable of performing Data Collection for AI/ML model training. The received message (e.g., the first RRC message) may indicate the conditions under which the WTRU can perform Data Collection as described in further detail below. The received RRC message (e.g., a first RRC message) may indicate (e.g., as part of the WTRU radio capability) that the WTRU can perform Data Collection and what model training the WTRU supports.

The RAN node may send a message (e.g., a second message) to the DCSF. The message (e.g., the message to the DCSF) requests permission to execute Radio Operation using AI/ML-based procedures. The message (e.g., the message to the DCSF) may indicate the ML model ID(s) of supported feature(s), and/or feature IDs that may be supported using similar (e.g., equivalent) AI/ML-based procedures (e.g., CSI, Beamforming, and/or Positioning).

The RAN node may receive a message from the DCSF. The message (e.g., the message received from the DCSF) includes an indication of whether the permission is granted for using AI/ML-based procedures to execute Radio Operations and/or indicates policies to determine a set of supported AI/ML based features, a Data Collection termination point (e.g., OTT or OAM), and/or an allowed model training type as described in further detail below. The message (e.g., the message received from the DCSF) may indicate an area where certain AI/ML based functionality can be executed and/or or location regions and/or areas where Data Collection can be conducted.

If the RAN node is allowed to use AI/ML-based procedures to execute Radio Operations, the RAN node may send an RRC message (e.g. a second RRC message) to the WTRU. The message (e.g. the second RRC message) indicates to the WTRU details of the Data Collection process as described in further detail below. The message (e.g. the second RRC message) is constructed based on the AI/ML policies received from the DCSF. The RRC message (e.g. the second RRC message) may indicate its support Data Collection Functionality. The message (e.g. the second RRC message) may indicate what model training type the WTRU is allowed to use, ML model ID(s) of the allowed ML models, and/or a training correlation ID the WTRU may use to identify the training process for which Data Collection is to be performed.

The RAN node may receive an RRC message (e.g., a third RRC message) indicating that the WTRU has accepted the Data Collection configuration (e.g., indicating that the WTRU can only support WTRU-side model training). This RRC message (e.g., the third RRC message) may indicate that Data Collection Functionality is supported.

The RAN node may determine an ML training procedure based on the WTRU data collection and ML model training capabilities

The RAN node may send a request to the DCSF to trigger a Data Collection procedure based on the determined ML training procedure.

A WTRU may perform any combination of the following actions (e.g., steps). First, the WTRU may send an RRC message (e.g., a first RRC message) to the Network. The message (e.g., the first RRC message) indicates Data Collection measurements, and it may provide neighboring Data Collection Capabilities (e.g., whether a neighboring RAN node supports joint and/or separated ML model training and associated Data Collection). The NAS message (e.g., transported in the first RRC message) may be sent to a Data Collection Server Function. The message (e.g., the first RRC message and/or the NAS message) may indicate the conditions under which the WTRU can perform Data Collection as described in further detail below. The RRC message (e.g., the first RRC message) may indicate (e.g., as part of the WTRU radio capability) that the WTRU can perform Data Collection and what model training (e.g., which types of model training) the WTRU supports.

Second, the WTRU may receive an RRC message (e.g., a second RRC message) from the Network. The message (e.g., the second RRC message) indicates to the WTRU details of the Data Collection process supported by the target RAN node, as described in further detail below. The RRC message (e.g., the second RRC message) may be received from a RAN node indicating that the WTRU should stop the Data Collection Process. The RRC massage (e.g., the second RRC message) may be received from a RAN node indicating a new Data Collection configuration as determined by a target RAN node (e.g., the training type that the target RAN node may support). The WTRU may determine not to support the new Data Collection configuration and stop the Data Collection process.

Third, the WTRU may move to a new cell in the target RAN node, and determine whether the WTRU may continue or terminate the Data Collection process (e.g., based on AI/ML Data Collection policies).

Fourth, the WTRU may send an RRC reconfiguration complete message to the target RAN node to acknowledge that the data collection reconfiguration is complete.

Fifth, the WTRU may consider, while in RRC_IDLE, aspects of the Data Collection configuration negotiated with the RAN node (e.g., the target RAN node), and the WTRU may determine whether to reselect a cell or not (e.g., Data Collection for specific WTRUs may be enabled in certain frequencies).

Sixth, while the WTRU is in an idle mode (e.g., RRC_IDLE mode), the WTRU may read System Information regarding Data Collection capabilities of the current RAN node (e.g., the target RAN node), and the WTRU may determine, based on these data collection capabilities, whether camping on the current node is warranted.

Seventh, the WTRU may report (e.g., when Data Collection measurements are provided by neighboring RAN nodes) the Data Collection capabilities of neighboring RAN nodes.

Described herein are examples of how transfer of standardized data over UP for WTRU data collection can be implemented to meet requirements for AI/ML for NR air interface operation with WTRU-side model training.

In an example, one or more requirements on Data Transfer of Data Collection may apply. For instance, a requirement may specify that Data Collection when a First Termination entity is a Server (e.g., OTT Server), the AI/ML data transfer path is WTRU->CN->OTT, and/or the collected data is transferred over a User Plane Connection.

Another requirement may specify Data Collection when the First Termination entity is the OAM system, the AI/ML data transfer path is WTRU->gNB->OAM->OTT, and/or the collected data is transferred over a User Plane Connection.

In an example, one or more requirements on Data Collection may apply. For instance, a requirement may specify that the data collected is secured and data integrity and confidentiality for that data are ensured. A requirement may specify that user data privacy, anonymity, and/or user consent are respected. A requirement may specify that the mobile network operator (MNO) has full control of the standardized data collection transfer process and can manage data transfer to the OTT server for WTRU-side data collection without the need of an SLA for this purpose. This may include initiating, terminating, and/or fully managing data transfer. A requirement may specify that the MNO has full visibility for standardized data. A requirement may specify that the design is futureproof and extendable.

A plurality of use cases have been considered when considering the possibility of using AI/ML to enhance current RAN procedures.

The application provides example use cases related to scenarios when AI/ML-aided RAN procedures are used, and AI/ML model inference is located at the gNB, while the ML Model Training (e.g., the ML Training entity) is located at the OAM system. These three use cases include Load Balancing, Mobility Optimization, and Energy Efficiency.

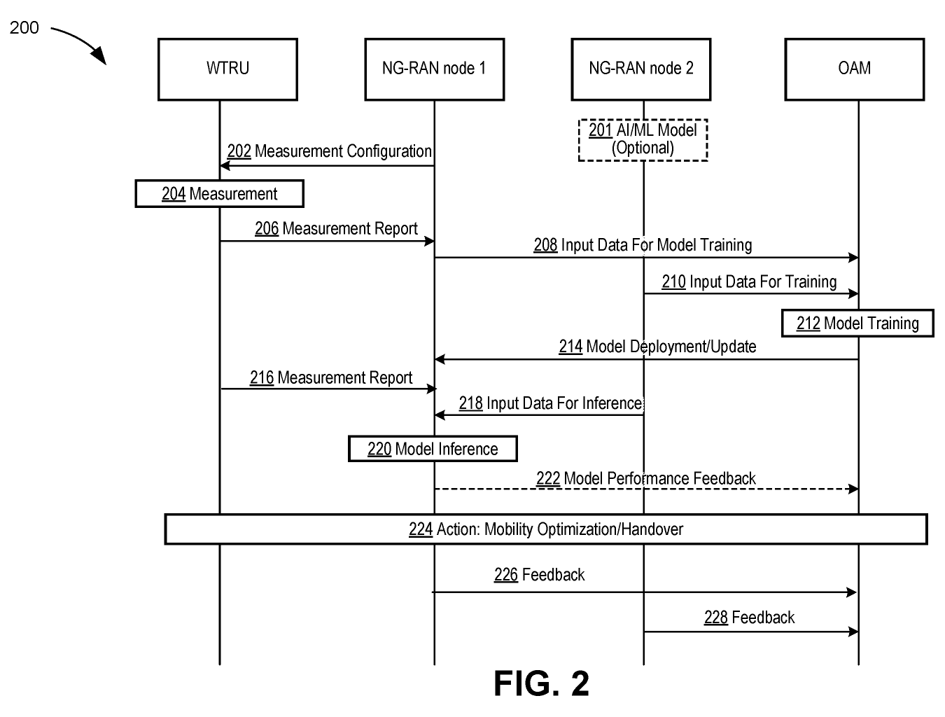

FIG. 2 illustrates a diagram 200 that depicts an example of a procedure specifically addressing Mobility Optimization. Note that inputs to enable the OAM system to train the ML Model may come from one or more base stations as illustrated in FIG. 2.

For Model inference at the WTRU and/or RAN (e.g., including both WTRU-sided and two-sided model cases), three Use Cases were considered: Positioning, Channel State Information (CSI), and Beam Forming.

Regarding data collection for the purpose of ML training for both WTRU-Side and two-sided cases (e.g., involving CSI prediction and CSI compression use cases respectively), training data generated at the WTRU can be trained (e.g., used to perform training) at the OTT Server. As such, mechanisms that address these scenarios should be considered.

As described above, some use cases (e.g., such as CSI compression) may require ML models to be trained for both WTRU-side and two-sides cases. When this scenario is considered, one question that arises is how it can be ensured that the training entity (e.g., the OTT Server) trains ML models to be used for the joint inference procedure (executed during the two-sided CSI compression use case) to comply with the conditions for Joint training. For example, there may be coordination aspects to be considered (e.g., for training collaboration). Furthermore, there may be reasons to tag and/or label an ML model to enable seamless ML training for such a use case.

Examples of cases to be considered are listed below.

In one case (type 1), joint training of the two-sided model occurs at a single side and/or entity (e.g., WTRU-sided or Network-sided).

In another case (type 2), joint training of the two-sided model occurs at the network side and the WTRU side, respectively.

In another case (type 3), separate training occurs at the network side and WTRU side, where the WTRU-side CSI generation part and the network-side CSI reconstruction part are trained at the WTRU side and the network side, respectively. Separate training may include sequential training starting with WTRU-side training or sequential training starting with network-side training.

In some examples, joint training may refer to the generation model and reconstruction model that is trained in the same loop for forward propagation and backward propagation. Joint training could be done both at a single node or across multiple nodes (e.g., through gradient exchange between nodes).

One detail to consider is how data collection may be carried out to enable joint training at the Training entity.

Other details may also be worthy of consideration. For example, there may be details to consider when Data Collection preparation procedures have been initiated, but the gNB has not yet triggered the Data Collection transfer procedure. Furthermore, there may be additional details to consider when the WTRU moves away from the gNB that initiated the Data Collection procedures. For instance, the details about what happens if the target gNB does not support AI/ML based CSI compression and/or another use case may be worth considering.

This specification addresses details of the Data Collection procedure that may have to be specified when a RAN node that is configured to apply AI/ML-based enhancements to certain Radio Network procedures (e.g., CSI compression or CSI predictions) triggers a Data Collection mechanism for the purpose of ML model training. Some of these details pertain to the determination taken by the RAN node (e.g., based on configuration) to apply WTRU-side or two-sided Model training.

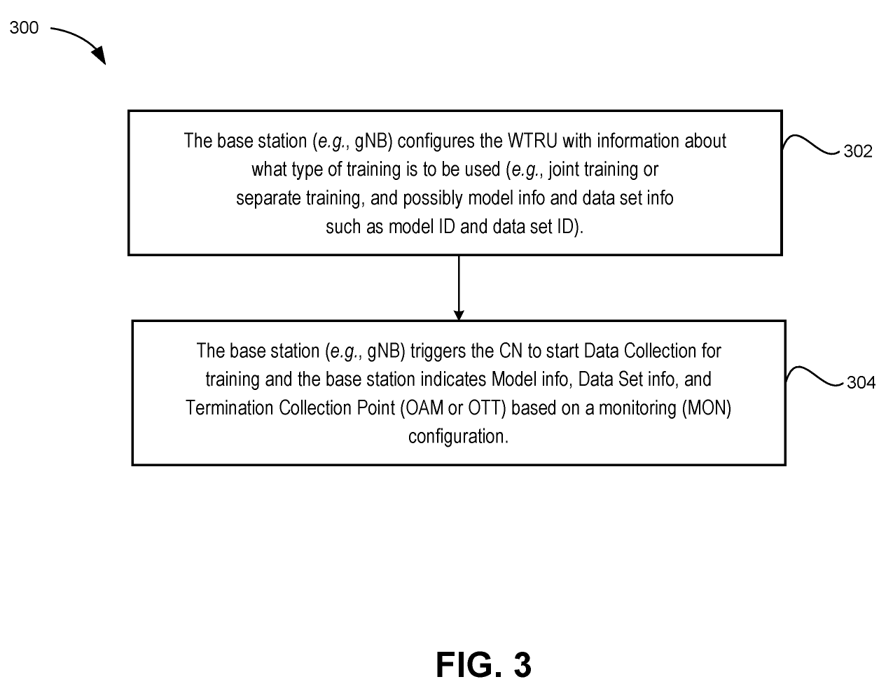

FIG. 3 illustrates a flow chart 300 that describes an example of a high-level procedure that triggers Data Collection from the RAN node once the RAN node has determined the type of ML model training to be used.

At block 302, a base station (e.g., gNB) configures a WTRU with information about what type of training is to be used (e.g., joint training or separate training, and possibly model info and data set info such as model ID and data set ID).

At block 304, the base station (e.g., gNB) triggers the Core Network (CN) to start Data Collection for training and the base station indicates Model info, Data Set info, and a Termination Collection Point (OAM or OTT) based on a monitoring (MON) configuration.

As part of an offline model training procedure, the RAN and the WTRU may agree on the type of ML Model inference to use—e.g., whether a WTRU-side model or a two-sided model may be used. In addition, the RAN and the WTRU may agree to identify the ML model with a Model ID and the Dataset(s) to be used with a training Dataset ID, depending on the feature the ML model is implementing. The initial stage may entail actions, for example, as described in the examples below.

The RAN and the WTRU may agree on the dataset and features (e.g., CSI prediction), subject to AI/ML processing, that the NW and the WTRU may use. The RAN and the WTRU may agree on whether the ML model inference may be run on the WTRU alone (e.g., a WTRU-side model), the RAN alone (e.g., RAN side model), or both the RAN and the WTRU (e.g., a two-sided model). The RAN and the WTRU may identify the ML model ID(s) and training dataset ID(s) to be used.

In an example, if the ML model is a two-sided model, the RAN and the WTRU may agree on the training type (e.g., identify whether joint training or separate training is to be used). In one example, it is possible that the separate training is to be used, but the decision for training and model selection be done in coordination between both sides.

In an example, if separate training is to be used, the RAN and the WTRU may identify whether sequential training is used and/or whether the WTRU or the RAN starts the training.

In an example, if joint training is to be used, the RAN and the WTRU may identify whether simultaneous training or sequential training is to be used.

In an example, if joint training is to be used, for a CSI UC, the RAN and the WTRU may may agree that both the generation model (at the WTRU) and the reconstruction model (at the RAN) are to be trained in the same loop, and thus ensure that data used to train these models is available for both models within a certain time window.

The network (e.g., RAN, CN, LMF, OAM, and/or any other NF and/or entity within the network) may be involved in several ways during the data collection. Some examples of ways the network may be involved during the data collection are listed below. In an example (option A), the network configures the measurements for data collection. In an example (option B), the network is the entity that controls the initiation and/or stoppage of the data collection. In an example (option C), the network is the entity that configures the data collection. In an example (option D), the network also participates in the data collection. It should be noted that the different options above are not mutually exclusive. Some example combinations are listed below.

In an example (options A and B), data collection configuration may come from an entity outside the network, the WTRU may send a request to the network for measurement configuration that is relevant to the configured data collection, and the network may provide the WTRU with the measurements and enable, activate, and/or initiate the WTRU to do the data collection.

In an example (options A and C), the network provides both the data collection configuration and the measurement configuration that is used for the WTRU to do the data collection.

In an example (options A and D), data collection is being performed concerning a two-sided model and both the WTRU and the network are involved in the data collection. The configuration of what the network collects may originate from the network (e.g., if the training is to be done within the network) or it may even originate from outside the network (e.g., an OTT server that is used for training the network side of the two-sided model or training both the WTRU-side and network side models, etc.).

For the case of data collection for two-sided models, the data collected by the WTRU and the data collected by the network may have to be correlated.

To illustrate this, consider a use case of CSI compression where a WTRU-side model infers a compressed version of the CSI and the network-side model decompresses it, and suppose the data is being collected for retraining or performance monitoring, and as such both the WTRU-side and network side models are activated doing the compression and decompression. For this use case, the final data that is to be compiled may at least have to contain information that specifies the ground truth (e.g., actual CSI information), the compressed CSI information, and the uncompressed CSI information.

In one example, the WTRU and the gNB may initialize some initial counter values (e.g., that are incremented each time an inference is made by the models) and each time the WTRU does the inference, the WTRU may increment the counter value and may log the compressed CSI, the ground truth (e.g., actual measured CSI), and the counter value. The gNB may do something similar—e.g., increment the counter, log the received compressed CSI, and log the inferred uncompressed CSI. This may enable the WTRU and the network to send the data to the training entity (e.g., within the network or outside the network) independently and the data collection entity to compile the data in a meaningful way using the inference counter values.

In some instances, instead of using the inference counter mentioned above, is to use time related information (e.g., a timestamp that indicates the current time—e.g., actual time, system frame/slot number, etc.).

Similar to the case where the WTRU may do several data collection procedures at once, the network may also be configured with a data collection ID (e.g., in the case of data collection for two-sided models, both the WTRU may be configured with the same data collection ID), and both the WTRU and the network may tag the collected samples with the data collection ID.

In the case of data collection for performance monitoring or retraining/re-tuning of a two-sided model, both the WTRU and the network may be configured to include the model IDs they are in the collected data samples (e.g., with each sample, or a separate entry that indicates that until a subsequent entry indicates another model, the model indicated in the current sample is to be assumed, etc.).

When the RAN triggers the Data Collection towards the Core Network, the characteristics of the models to be trained may have to be known, as these characteristics may involve different data collection mechanisms.

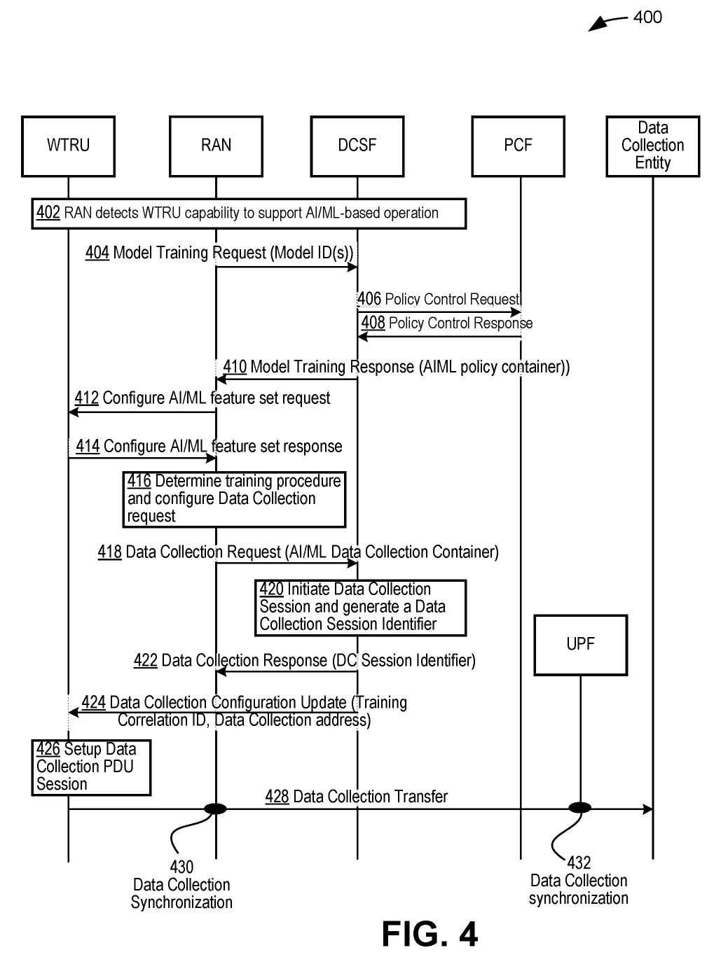

FIG. 4 illustrates a diagram 400 of an example procedure for initiating data collection. As shown, the diagram 400 depicts a series of steps (steps 402 through 432). Persons of skill in the art will recognize that some of the steps may be performed in orders other than the order shown, some steps may be performed concurrently, some steps may be omitted, and steps not shown may also be performed without departing from the spirit and scope of this disclosure.

In step 402, both the RAN and the WTRU may provide their Data Collection Capabilities to the DCSF. The RAN may provide its Data Collection Capability during the N2/NG setup procedure, or with a new service operation if an SBA is supported. The WTRU may provide its Data Collection Capability during the Registration procedure in a NAS message, and in some examples, may additionally provide its Data Collection Capability to RAN in the RRC message carrying the NAS message intended for the DCSF. In some examples, when the RAN starts the Data Collection Configuration procedure, the RAN may fetch the WTRU Data Collection Capability from the DCSF or the RAN may obtain the WTRU Data Collection Capability, and/or whether the WTRU is able to support some AI/ML-based operation (e.g., CSI compression and/or CSI prediction) (e.g., as part of the WTRU Radio Capability).

In step 404, the RAN may trigger ML model training. The RAN may request permission from the DCSF to operate certain features using AI/ML. The RAN may provide the ML model ID(s) of a required or supported feature. Alternatively or additionally, the RAN may provide the feature IDs (e.g., CSI, Beamforming or Positioning). The RAN may provide a WTRU ID. In addition, the RAN may generate a training correlation ID to help the DCSF identify a training process or to identify a specific training loop which may be useful (e.g., if training is conducted separately for two-sided training cases).

As described in step 402, the WTRU may have already registered its capabilities to the DCSF (e.g., during a registration procedure). The RAN decides to trigger ML model training data and may indicate to the DCSF that the RAN supports coordinated model training ( e.g., for a single-sided or two-sided model) and sequential and/or simultaneous model training. The RAN may also indicate the users (WTRUs), location(s), and/or application(s) of interest to DCSF. Based on the request, the DCSF may provide preferences on how the coordination between the RAN and the WTRU should be achieved. The DCSF may provide configuration that includes preferences on whether a single or two-sided model should be adopted. The DCSF may also indicate whether joint or separate and sequential or simultaneous training should be preferred. The DCSF may also indicate these preferences to the relevant WTRUs and provide the WTRU IDs to the RAN. For this example, in one scenario, the RAN and the WTRU may decide on the model training based on the DCSF configurations and ignore any previously stored policy and/or preferences.

In step 406, the DCSF may send a Policy Control Request to the policy control function (PCF) to request AI/ML policies. The DCSF provides Feature IDs, ML model information associated with the requested Feature ID, and the supported Data Collection entities (e.g., the OTT or the OAM).

In step 408, the PCF may fetch Subscriber information from the unified data repository (UDR) (e.g., to determine User Consent and allowed AI/ML-based features— e.g., User Consent may be provided to determine whether AI/ML based procedures can be used to replace equivalent legacy Radio procedures, particularly when data on WTRU IDs or user positioning are collected and provided to the Data Collection Termination point). The PCF may use the requested Feature IDs and ML model information provided by the DCSF in step 406 to derive AI/ML Policies, including Data Collection and/or ML Model delivery. In step 408, the PCF may provide the derived policies to the DCSF (e.g., using a PCC rule), including policies to determine set of supported AI/ML-based features, Data Collection termination point (e.g., OTT or OAM) and allowed model training type (e.g., Separate or Joint training, sequential or simultaneous training). Policies may also be provided to control the area where certain AI/ML-based functionality can occur, or location regions or areas where Data Collection can be conducted. For example, the PCF (e.g., based on subscriber data and/or WTRU context stored in the UDR and/or unified data management (UDM)) may derive a location policy that specifies where training, data collection, and inference can be conducted. These policies may involve the definition of an area (e.g., Data Collection area of service (AoS), Training AoS, and/or Inference AoS).

In step 410, the DCSF may send a model training response to the RAN. The response includes an indication of whether the permission is granted for using AI/ML-based procedures to execute Radio Operations and includes the policy information obtained from the PCF.

In step 412, based on the AI/ML policies received from the PCF (via the DCSF), the WTRU and the RAN may negotiate ML model training type, ML Models, and Datasets. To this end, the RAN configures the WTRU with the allowed AI/ML model information. In addition, the RAN sends the training correlation ID (generated in step 404) to the WTRU and, if the WTRU accepts the RAN AI/ML configuration, it may use the training correlation ID for further processing. For example, it may be used to identify training loops when the WTRU moves from one gNB to another. Note that the over-the-air negotiation and data transmission may have to be integrity-protected and replay-protected and may be confidentiality-protected based on the operator security policy.

In step 414, the WTRU may send an AI/ML configuration response (e.g., accepting or rejecting the proposed configuration and indicating what the WTRU is capable and willing to accept—e.g., the WTRU may only support WTRU-side model operation). Note that the over-the-air negotiation and data transmission may have to be integrity-protected and replay-protected and may be confidentiality-protected based on the operator security policy.

In step 416, the RAN, based on the response from the WTRU, may determine the agreed-upon ML training procedure (e.g., whether a WTRU-side model or two-sided model is to be used and, if the two-side model is used, whether joint or separate training is to be used and whether sequential or simultaneous training is used), the set of AI/ML-based features, and the chosen Data Collection Termination point (e.g., OAM or OTT). The RAN may also indicate (e.g., based on the ML training type) whether the Data Collection termination point needs to be chosen such that the collected data be used to train ML models in the same loop (e.g., when the training type is joint training).

In step 418, the RAN node may trigger a Data Collection procedure by sending a Data Collection request to the DCSF and providing the AI/ML Data Collection container with information as determined in step 416. If a Data Collection Session already exists, the RAN may send the associated Data Collection Session identifier.

In step 420, in response to receiving the Data Collection procedure request, the DCSF may initiate a data collection session for relevant WTRU(s) included in the Data Collection procedure. As part of establishing the data collection session, the DCSF may assign a DC session identifier which uniquely identifies the data collection session. The DC session identifier may be based on (e.g., mapped to) the training correlation ID the RAN provided to the DCSF in step 404. Note that the Data Collection Request may come from the OTT or from the WTRU (e.g., if the WTRU is triggered over the Application Layer by an OTT server). If a Data Collection Session already exists, the OTT or the WTRU may provide the associated Data Collection Session identifier.

In step 422, the DCSF may send a Data Collection response to the RAN node. The response includes an indication that the DC session has been created and further includes a DC session identifier. The RAN node may store the DC session identifier along with the associated configuration agreed upon in step 414 and may use the DC session identifier to correlate the DC session with the agreed-upon configuration. The RAN may map the DC session identifier to the training correlation ID generated in step 404.

In step 424, the RAN node may send a Configuration update notification to the WTRU. The notification may include the training correlation ID negotiated in step 412, which is associated with the agreed-upon configuration. The WTRU may use the training correlation ID to correlate an incoming DC session with the agreed-upon configuration.

The DC session identifier and/or mapped training correlation ID passed during backpropagation towards the RAN and the WTRU in step 420 may have to be used when multiple DC sessions are triggered (e.g., if multiple models and/or features are to be configured and trained concurrently).

In step 426, the WTRU may establish a PDU Session to start Data Collection transfer using the destination address of the Data Collection Entity (e.g., the OTT, the DCCF or the DCSF). The WTRU may use a dedicated address space, possibly derived from the DC Session ID, to generate the PDU Session ID, and use a new PDU Session Type (called a Data Collection PDU Session Type).

In step 428, the WTRU may start Data Collection transfer towards the destination address of the Data Collection Entity (e.g., the OTT, the DCCF or the DCSF) provided by the DCSF and transferred by the RAN in step 424.

In step 430, the RAN may, using the PDU Session ID and the Data Collection PDU Session Type, insert additional information correlated with Data Collection information provided by the WTRU.

In step 432, the user plane function (UPF) may, using the PDU Session ID and Data Collection PDU Session Type, insert additional information correlated with Data Collection information provided by the WTRU.

In one example scenario, if the RAN performs single-sided ML model training or the WTRU performs WTRU-side model training or both, and the data is collected by both WTRU and the RAN for the model training, then there is a possibility that the two data sets may be different and may have to be normalized.

The collected data may be different in terms of number of parameters, frequency of data collection, collected data storage and/or buffering capacity, etc. The differences in the data sets collected at the WTRU and the RAN may be because RAN has more computational and processing power than the WTRU and/or that RAN is exposed to more information than the WTRU (e.g., the RAN may not experience power limitations as the WTRU may because of low power or power saving mode, if enabled).

Similarly, there may be several factors that may lead to differences in collection of data. However, if the similar AI/ML models are intended for both the WTRU and the RAN, then the anticipated data collection should be similar (e.g., the same). Hence, the configurations from the DCSF (in step 422) may provide additional information on how to achieve the normalization (e.g., when the data is collected it may be time stamped, or when joint data model training is intended the frequency of data collection may be harmonized, etc.).

Once Data Collection has been triggered, a WTRU or WTRUs participating in the Data Collection procedure may move away from the gNB that configures them for Data Collection. Furthermore, if the Data Collection procedure involves more than one WTRU, different scenarios may also be considered—e.g., the gNB that originally triggered the Data Collection procedure may determine to keep using the measurements from WTRUs that are no longer connected to it, or the gNB may keep getting WTRU measurements (e.g., provided by the neighboring gNB that is now serving the WTRU). This determination may be based on the AI/ML area policy provided by the PCF during the Data Collection Initiation procedure.

In the handover (HO) request message, the source gNB may indicate information related to the data collection that is being performed by the WTRU that is being handed over. This information may be dependent on the ways the source gNB is involved in the data collection process. Several examples of how the source gNB may be involved are discussed below.

If the source gNB is involved only in the measurement configuration that is used for data collection (option A above), the source gNB may include the measurement configuration that is being used by the WTRU and also for what these measurements are being used.

If the source gNB is involved in the initiation and/or stoppage of the data collection procedure (option B above), then the WTRU may be instructed to stop and/or pause the data collection procedure during the HO (e.g., there could be an indication and/or flag in the HO command that indicates to the WTRU to stop and/or pause the data collection, or it may be assumed by the WTRU that the data collection is stopped until further instruction from the target gNB).

If the source gNB is the entity that configured the data collection configuration, then the source gNB may provide the details of the data collection configuration and the target gNB may indicate to the source gNB if the data collection configuration can be accepted at the target cell (e.g., fully or partially). The source gNB may base the decision to hand over the WTRU or not based on this response (e.g., similar to the case where the source gNB can reject a HO to a certain target gNB if the target gNB was able and/or willing to admit only a fraction of the WTRUs data radio bearers (DRBs), etc.).

If the source gNB was involved in the data collection procedure as in option D above (e.g., in the case of data collection for performance monitoring and/or retraining of a two-sided model), then the source gNB may inform the target gNB regarding the data type being collected, the model ID of the network-side model being used, etc., and the target gNB may respond in the HO acknowledgment (ACK) if that data collection may continue at the target gNB as well. The source gNB may base the decision to hand over the WTRU or not based on this response.

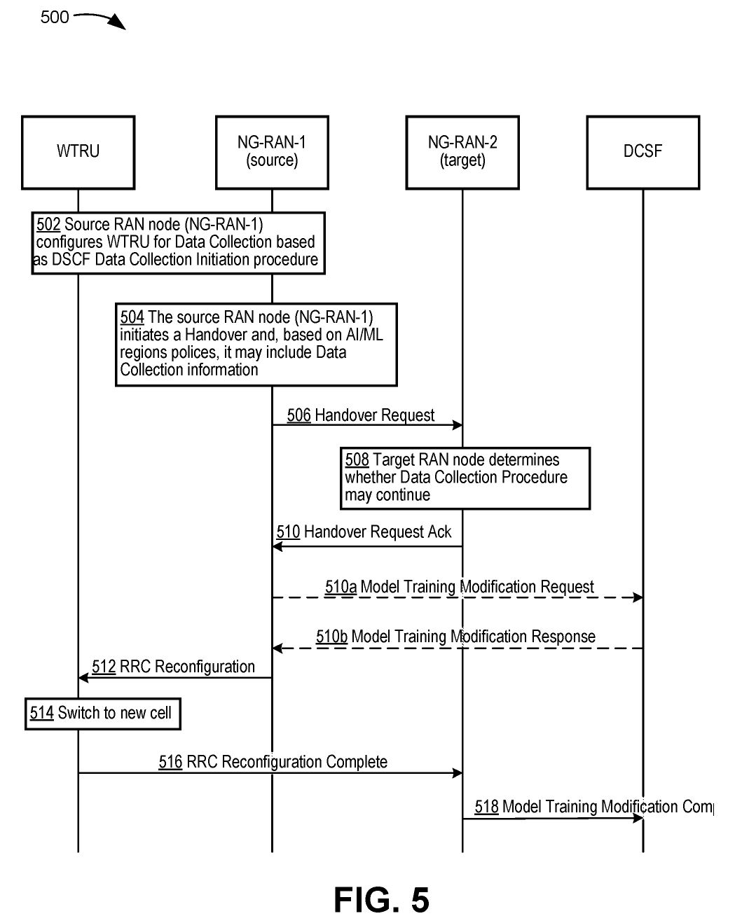

FIG. 5 illustrates a diagram 500 of an example procedure for mobility consideration for data collection. As shown, the diagram 500 depicts a series of steps (steps 502 through 518). Persons of skill in the art will recognize that some of the steps may be performed in orders other than the order shown, some steps may be performed concurrently, some steps may be omitted, and steps not shown may also be performed without departing from the spirit and scope of this disclosure.

In step 502, the source RAN node may configure the WTRU for Data Collection based on guidelines received from the DCSF.

In step 504, the source RAN node may initiate a Handover procedure and may use AI/ML Regions policies to determine whether Data Collection for this WTRU should continue, be put on hold, or stopped. The source RAN node may know AI/ML Region policies and Data Collection capabilities from the target RAN node through configuration during an Xn setup procedure or by fetching this information from the DCSF. In addition, if an SBA architecture is supported, the source RAN may use the NRF to get this information. If the Data Collection AI/ML Region policy (e.g., the Data Collection QoS policy) indicates that the target RAN node is allowed, the source RAN node requests from the target RAN node that the Data Collection be continued.

In step 506, the source RAN node may issue a Handover Request, and the source RAN node may provide Data Collection parameter(s) that enable the target RAN node to determine if the target RAN node accepts to continue the Data Collection procedure and, if so, to what extent. To this end, the source RAN node may provide the AI/ML Region and/or Area policies, the DCSF address and/or or OAM trace collection entity (TCE) ID, ML model ID(s), a list of WTRUs, and possibly a training correlation ID. The source RAN node may also indicate whether Data Collection may be transferred directly to the Data Collection entity (e.g., an OTT server or the OAM system, either through the UPF serving the Data Collection PDU Session or using signaling procedures), the DCSF, or the source RAN node. If a DC session has already been initiated for the WTRU, the message may include the DC session identifier associated with the DC session.

In step 508, the target RAN node, based on the Data Collection information provided by the source RAN node, and the target RAN node’s own capabilities and/or configuration and/or MNO policies, may determine whether the Data Collection procedure can continue for the relevant WTRU, and how (e.g., the target RAN node may only support WTRU-side model training or two-sided model training).

In step 510, the target RAN node may issue a Handover Request Acknowledgement and provide the Data Collection support the target RAN is willing to provide (e.g., whether the ML Model is available, the training type—e.g., joint training or separate training, and the reporting capabilities—e.g., whether the target RAN node can deliver Data Collection toward the appropriate Data Collection entity such as a DCSF/DCCF, an OAM TCE, or an OTT).

In step 510a, if the source RAN node determines that an ongoing data collection (DC session) cannot continue, the source RAN node may send a message to the DCSF to terminate the DC session for the associated WTRU. The message may include the WTRU identifier and the SC session identifiers.

If the RAN node determines that an ongoing DC session can continue and determines that the agreed-upon configuration is different, the source RAN node may send a message to the DCSF to update the DC session for the associated WTRU. The message may include the WTRU identifier and the SC session identifiers and the updated DC session parameters. The source RAN node may also include the address of the target RAN node that is taking over the Data Collection process in the message.

Note that if the target RAN node cannot support the Data Collection session (e.g., the target RAN node does not have access to the current UPF serving the Data Collection PDU Session), then the source RAN node may transfer the Data Collection context information to the Mobility Management Function (MMF) in the Core Network. The MMF may use this context to update a target UPF (e.g., via an SMF) (e.g., that may have to correlate Data Collection streams from multiple WTRUs or from the serving RAN node and the WTRU(s) collecting measurements for Data Collection).

In step 510b, the DCSF may acknowledge the Training Session Modification request and indicate whether the Data Collection process is allowed to continue in the target RAN node.

In step 512, the source RAN node may transfer the target RAN node reconfiguration for the WTRU. Depending on the target RAN node response to the Data Collection continuation request, the reconfiguration may either stop the Data Collection procedure or configure the WTRU with new Data Collection information (e.g., both the source and target RAN nodes may have agreed to change the ML training type).

The message may include the training correlation ID and an indication of whether the associated DC session should be terminated or has been updated. If the message indicates DC session termination, the WTRU may stop the associated data collection for the DC session identifier prior to performing the handover in step 514. If the message indicates a DC session update, the WTRU may modify the associated data collection parameters according to the agreed-upon configuration with the target RAN node for the DC session identifier prior to performing the handover in step 514.

In step 514, the WTRU may switch to the new cell.

In step 516, the WTRU may acknowledge that RRC configuration to the target RAN node (e.g., by sending an acknowledgement). The WTRU may choose not to accept the Data Collection configuration (e.g., the WTRU does not accept the ML model configuration proposed by the target RAN node).

In step 518, using the DC session identifier, the target RAN may inform the DCSF that the Training Session Modification procedure for Data Collection has been completed.

1. A Radio Access Network (RAN) node, comprising:
a processor configured to:
send a request for permission to initiate data collection associated with training of an artificial intelligence/machine-learning (AI/ML) model;
receive, after the request is sent, an indication that permission is granted to initiate the data collection;
send artificial intelligence/machine-learning (AI/ML) configuration information to configure a wireless transmit/receive unit (WTRU) to perform the data collection;
receive, after the AI/ML configuration information is sent, a message indicating one or more data collection capabilities of the WTRU;
determine, based on the one or more data collection capabilities of the WTRU, an ML training procedure for training the AI/ML model;
send a data collection request, wherein the data collection request initiates the data collection;
receive, after the data collection request is sent, a data collection response, wherein the data collection response comprises a data collection session identifier associated with the data collection; and
send a notification to the WTRU, wherein the notification comprises additional AI/ML configuration information to configure the WTRU to perform the data collection based on the response to the data collection request.

2. The RAN node of claim 1, wherein the processor is further configured to:
prior to sending the request for permission to initiate the data collection associated with training of the AI/ML model, send a message indicating one or more data collection capabilities of the RAN node.

3. The RAN node of claim 1, wherein the processor is further configured to:
generate a training correlation identifier (ID); and
send the training correlation ID to a data correlation server function (DCSF) to help the DCSF identify a training process associated with the training of the AI/ML model.

4. The RAN node of claim 3, wherein the AI/ML model is a WTRU-sided model, and wherein the training process is to be performed at the WTRU.

5. The RAN node of claim 3, wherein the AI/ML model is a network-sided model, and wherein the training process is to be performed at the RAN node.

6. The RAN node of claim 3, wherein the AI/ML model is a two-sided model, and wherein the training process is a joint training process that comprises at least one action to be performed by the RAN node and at least one action to be performed by the WTRU.

7. The RAN node of claim 3, wherein the processor is further configured to:
receive a destination address of a data collection entity associated with the data collection.

8. The RAN node of claim 7, wherein the processor is further configured to:
receive data that was collected by the WTRU while the WTRU performed the data collection.

9. The RAN node of claim 8, wherein the processor is further configured to:
receive, from the WTRU, a protocol data unit (PDU) session identifier (ID) that was derived from the data collection session identifier and an indication of a PDU session type;
use the PDU session ID and the PDU session type to insert additional information that is correlated with the data that was collected by the WTRU into a second message, wherein the second message comprises the data that was collected by the WTRU; and
send the second message to the destination address of the data collection entity.

10. The RAN node of claim 1, wherein the AI/ML configuration information indicates a plurality of AI/ML operations for the WTRU to perform, and wherein the message indicates that the WTRU is not capable of performing at least one of the AI/ML operations.

11. A method performed by a Radio Access Network (RAN) node, the method comprising:
sending a request for permission to initiate data collection associated with training of an artificial intelligence/machine-learning (AI/ML) model;
receiving, after the request is sent, an indication that permission is granted to initiate the data collection;
sending artificial intelligence/machine-learning (AI/ML) configuration information to configure a wireless transmit/receive unit (WTRU) to perform the data collection;
receiving, after the AI/ML configuration information is sent, a message indicating one or more data collection capabilities of the WTRU;
determining, based on the one or more data collection capabilities of the WTRU, an ML training procedure for training the AI/ML model;
sending a data collection request, wherein the data collection request initiates the data collection;
receiving, after the data collection request is sent, a data collection response, wherein the data collection response comprises a data collection session identifier associated with the data collection; and
sending a notification to the WTRU, wherein the notification comprises additional AI/ML configuration information to configure the WTRU to perform the data collection based on the response to the data collection request.

12. The method of claim 11, further comprising:
prior to sending the request for permission to initiate the data collection associated with training of the AI/ML model, sending a message indicating one or more data collection capabilities of the RAN node.

13. The method of claim 11, further comprising:
generating a training correlation identifier (ID); and
sending the training correlation ID to a data correlation server function (DCSF) to help the DCSF identify a training process associated with the training of the AI/ML model.

14. The method of claim 13, wherein the AI/ML model is a WTRU-sided model, and wherein the training process is to be performed at the WTRU.

15. The method of claim 13, wherein the AI/ML model is a network-sided model, and wherein the training process is to be performed at the RAN node.

16. The method of claim 13, wherein the AI/ML model is a two-sided model, and wherein the training process is a joint training process that comprises at least one action to be performed by the RAN node and at least one action to be performed by the WTRU.

17. The method of claim 13, further comprising:
receiving a destination address of a data collection entity associated with the data collection.

18. The method of claim 17, further comprising:
receiving data that was collected by the WTRU while the WTRU performed the data collection.

19. The method of claim 18, further comprising:
receiving, from the WTRU, a protocol data unit (PDU) session identifier (ID) that was derived from the data collection session identifier and an indication of a PDU session type;
using the PDU session ID and the PDU session type to insert additional information that is correlated with the data that was collected by the WTRU into a second message, wherein the second message comprises the data that was collected by the WTRU; and
sending the second message to the destination address of the data collection entity.

20. The method of claim 11, wherein the AI/ML configuration information indicates a plurality of AI/ML operations for the WTRU to perform, and wherein the message indicates that the WTRU is not capable of performing at least one of the AI/ML operations.
